(19) United States
(12) Patent Application Publication
(10) Pub. No.: US 2009/0108554 A1
(43) Pub. Date: Apr. 30, 2009

(54) SKATEBOARD DECK

(76) Inventors: Hugh Boyle, El Segundo, CA (US); Eben Woodall, Costa Mesa, CA (US); Chi Leung, Rancho Palos Verdes, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/172,983

(22) Filed: Jul. 14, 2008

Related U.S. Application Data
(60) Provisional application No. 60/949,786, filed on Jul. 13, 2007.

(51) Int. Cl. A63C 17/01; B32B 38/04

(52) U.S. Cl. 280/87.042; 156/253

(57) ABSTRACT

A skateboard deck is formed of several layers that are pressed and bonded together. One or more slots are formed through a plurality of the middle layers of such a deck, and an elongate rod is arranged within each slot. The elongate rods, when cured, are more rigid than the other layers of the skateboard deck, and provide impact dispersion and torsion resistance while allowing the remaining layers of the deck to retain their performance characteristics and feel.

### CROSS-REFERENCE TO RELATED APPLICATIONS

This application claims priority to U.S. Provisional Application No. 60/949,786, which was filed on Jul. 13, 2008, the entirety of which is hereby incorporated by reference.

### BACKGROUND OF THE INVENTION

1. Field of the Invention

The present invention relates to a skateboard deck, and more particularly to a skateboard deck having at least one member that absorbs and distributes forces within the skateboard deck.

2. Description of the Related Art

Skateboard decks constructed from laminated wood are well known. Typically, such laminated decks are constructed of several sheets, or veneers, of wood glued and pressed together to form a desired shape. Such a skateboard deck typically includes first and second truck mount portions at which wheeled trucks are attached to the deck, typically via bolts or screws extending through mount holes formed through the deck. Although such skateboard decks have attained wide acceptance, they suffer from drawbacks in terms of strength, weight and durability. For example, it is not uncommon for adjacent layers of such skateboard decks to separate during use. Further, Applicants have noted that skateboard decks are particularly vulnerable to wear and breakage along a zone or line generally adjacent to the truck mount holes closest to the middle of the skateboard deck.

Some efforts have been made to strengthen skateboard decks. Such efforts have included using additional materials, such as one or more layers of carbon fiber. Some decks are formed entirely of non-wood materials, and some wooden skateboard decks also comprise non-wood layers that significantly stiffen the skateboard deck. However, skateboarders are familiar with the feel and performance characteristics of wooden decks, and many skateboarders prefer the feel of such decks to alternatives that may incorporate different technologies and materials. Additionally, laminated wood skateboard decks can be made efficiently and inexpensively and thus are easily attainable on the market.

### SUMMARY OF THE INVENTION

Accordingly, there is a need in the art for a skateboard deck having a feel similar to a traditional wood deck, but having increased strength and durability without increased weight.

There is a further need in the art for a skateboard deck that is reinforced in the area(s) in which the deck is particularly vulnerable to breakage.

In accordance with one embodiment, the present invention provides a skateboard deck comprising a plurality of layers pressed and bonded together. The plurality of layers comprise an upper layer, a lower layer, and a middle layer. The middle layer has an elongate slot formed therein, the slot being generally parallel to a longitudinal axis of the skateboard deck. A rigid reinforcement rod is disposed in the elongate slot formed in the middle layer. The rod has a stiffness in bending greater than a stiffness in bending of the other layers. A plurality of mounting apertures extend through the upper, lower and middle layers. The elongate reinforcement rod extends longitudinally past the mounting apertures but is spaced from the mounting apertures.

In one such embodiment, the elongate slot does not intersect with a perimeter edge of the middle layer so that the reinforcement rod is enclosed in the slot by the upper, middle and lower layers.

In another embodiment, the skateboard deck has a plurality of middle layers, and elongate slots are formed in each of the plurality of middle layers so that the elongate slots are aligned with one another, and the rigid reinforcement rod is disposed in the aligned elongate slots.

In yet another embodiment, the reinforcement rod has a widened portion having a first width and a narrowed portion having a second width, and the first width is greater than the second width.

In a still further embodiment, the reinforcement rod has a composite wall, and a thickness of the composite wall varies along the length of the reinforcement rod.

A yet further embodiment comprises a second elongate slot formed in the middle layer and a second rigid reinforcement rod disposed in the second elongate slot, the first and second reinforcement rods being generally parallel to one another.

In some embodiments the reinforcement rods comprise a cured composite shell. In further embodiments, the cured composite shell generally encircles a foam core. In yet other embodiment, the reinforcement rods have a generally rectangular cross-sectional shape.

In another embodiment, the first reinforcement rod is disposed on a first side of a longitudinal axis of the skateboard deck, and the second reinforcement rod is disposed on a second side of the longitudinal axis. In a still further embodiment, the skateboard deck additionally comprises a truck mount portion, and each of the first and second reinforcement rods is disposed between the truck mount portion and a perimeter edge of the deck.

In accordance with another embodiment, the present invention provides a method of making a skateboard deck. The method includes providing a plurality of elongate layers of material, including an upper layer, a lower layer, and a plurality of middle layers, cutting an elongate slot in each middle layer, providing an elongate reinforcement rod having a length and width generally corresponding to a length and width of the elongate slot, and a thickness generally corresponding to an aggregate thickness of the plurality of middle layers, aligning the elongate slots of the middle layers, placing the reinforcement rod into the aligned elongate slots, assembling the upper, middle, and lower layers, applying an epoxy between the upper, middle, and lower layers, placing the assembled layers in a press, curing the epoxy in the press, and forming mounting apertures in the deck for attaching a wheel mechanism. The elongate slots are spaced from the mounting holes but extend longitudinally on either side of the mounting holes.

In accordance with one embodiment, providing the rod comprises providing an elongate foam member and wrapping the foam member with a prepreg fibrous fabric material.

In another embodiment, the prepreg material is co-cured with the epoxy in the press.

In a further embodiment the prepreg material is tacky so that it stays in place while being manipulated.

In still another embodiment, the foam member is adapted to expand upon heating, and curing the epoxy in the press comprises applying heat such that the foam member expands and exerts a force on the fibrous fabric material.

In some embodiments, the prepreg fibrous fabric material comprises carbon fiber.

### BRIEF DESCRIPTION OF THE DRAWINGS

FIG. 1 is a perspective view of a skateboard deck having features in accordance with the present invention.

FIG. 2 is an exploded view showing layers and components to be assembled during construction of a skateboard deck embodiment.

FIG. 3a is a schematic cross-sectional depiction of an elongate rod taken along lines 3-3 of FIG. 2, and schematically showing layers of composite material wrapped about a core.

FIG. 3b shows the rod of FIG. 3a in a cured disposition.

FIG. 4 is a top plan view of a skateboard deck as in FIG. 1.

FIG. 5 is a cross-sectional view of the skateboard deck of FIG. 4 taken along lines 5-5.

FIG. 6 is a top plan view of a skateboard deck in accordance with another embodiment, showing certain internal components in phantom.

FIG. 7 is a top plan view of a skateboard deck configured in accordance with still another embodiment, showing certain internal components in phantom.

FIG. 8 is a top plan view of a skateboard deck configured in accordance with yet a further embodiment, showing certain internal components in phantom.

### DETAILED DESCRIPTION OF PREFERRED EMBODIMENTS

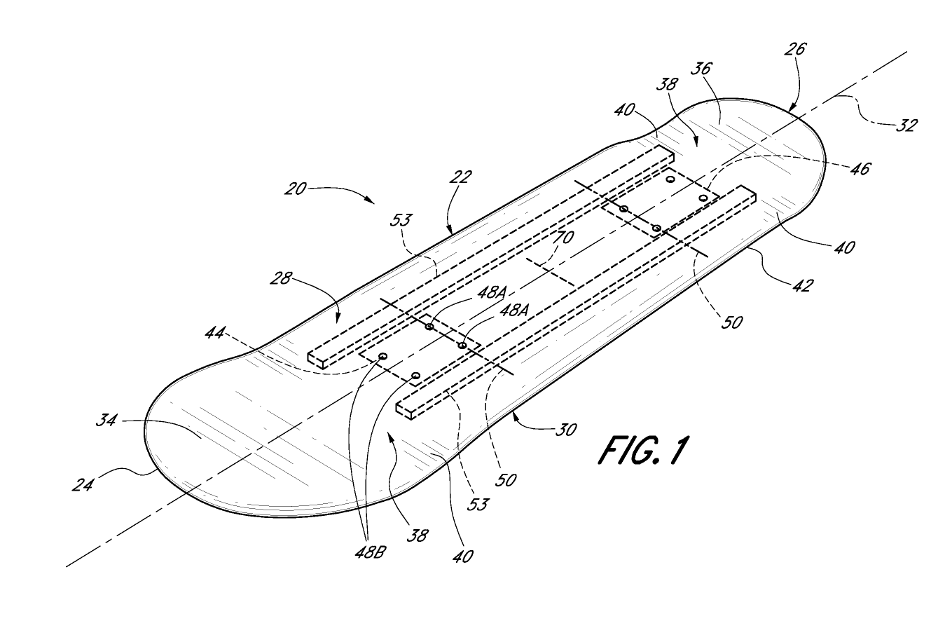

With initial reference to FIG. 1, an embodiment of a skateboard deck 20 is illustrated. The illustrated skateboard deck 20 has a planform shape approximating an elongated oval. The deck 20 comprises an elongate body 22 having first and second opposing ends 24, 26. A mid-length point 27 is disposed along the length of the deck 20 midway between the opposing ends 24, 26. Preferably, the skateboard deck 20 has a slightly concave upper surface 28 and a slightly convex lower surface 30 about a longitudinal axis 32 of the deck 20.

In the illustrated embodiment, a first tail 34 is formed adjacent the first end 24 and a second tail 36 is formed adjacent the second end 26. The first and second tail portions 34, 36 preferably are upturned, and there is a transition portion 38 between the body 22 and each upturned tail 34, 36. In each of the transition portions 38, hips 40 are formed generally along and adjacent an edge 42 of the skateboard deck 20 where the most dramatic change in curvature from the concave body 22 to the upturned tail 34, 36 occurs.

Such a skateboard deck 20 typically is configured to be attached to first and second wheeled trucks. As illustrated, first and second truck mount portions 44, 46 are defined on the bottom surface 30 of the deck 20 and indicated in the drawings by phantom lines. The mount portions 44, 46 generally delineate an anticipated outline of a skateboard truck base plate when such a truck is attached to the bottom surface 30 of the deck 20. Typically, mount apertures 48 are formed through the deck 20 and generally approaching the corners of the truck mount portions 44, 46. Corresponding apertures typically are formed in the corresponding truck base plate. As such, bolts and/or screws extending through the mount apertures 48 can secure the truck base plate to the deck 20.

In the illustrated embodiment, the first and second truck mount portions 44, 46 each have four mount apertures 48 spaced in accordance with a standard mount aperture pattern. In each mount portion, two of the mount apertures 48 are considered inner mount apertures 48a, and are positioned closer to the mid-length point 27 than the other two mount apertures, which are labeled outer mount apertures 48b. The outer mount apertures 48b of each mount portion are disposed further from the mid-length point 27 and closer to the tail transition portion 38 than the associated inner mount apertures 48a.

Applicants have noted that, during use, skateboard decks are particularly vulnerable to wear and breakage along a zone or line 50 generally at or adjacent the inner apertures 48a in each truck mount portion 34, 36. This vulnerability zone 50 demarcates a portion of the deck 20 that is most likely to be exposed to the greatest stress concentrations during impacts and the like that can be expected during skateboarding, especially during high performance skateboarding in which the skateboarder becomes airborne and exerts great pressures when landing upon the deck 20.

Applicants have also noted that wooden decks are particularly vulnerable to twisting such as due to torsional forces on the skateboard. While some flexibility may be desired, excessive flexibility in torsion can give a skateboard deck imprecise and sloppy performance.

With continued reference to FIG. 1, a pair of elongate rods 53 are disposed within the skateboard deck 20 and extend generally parallel to the longitudinal axis 32 of the deck 20. Preferably, the elongate rods 53 are spaced from the truck mount portions 44, 46 so that the rods 53 do not interfere with or contribute to mounting of the trucks. Additionally, preferably the rods 53 are stiffer than the material, such as wood, used to make the rest of the skateboard deck 20. In a preferred embodiment, the rods 53 comprise generally hollow or foam-filled elongate carbon fiber tubes 54 having a generally rectangular cross-sectional shape.

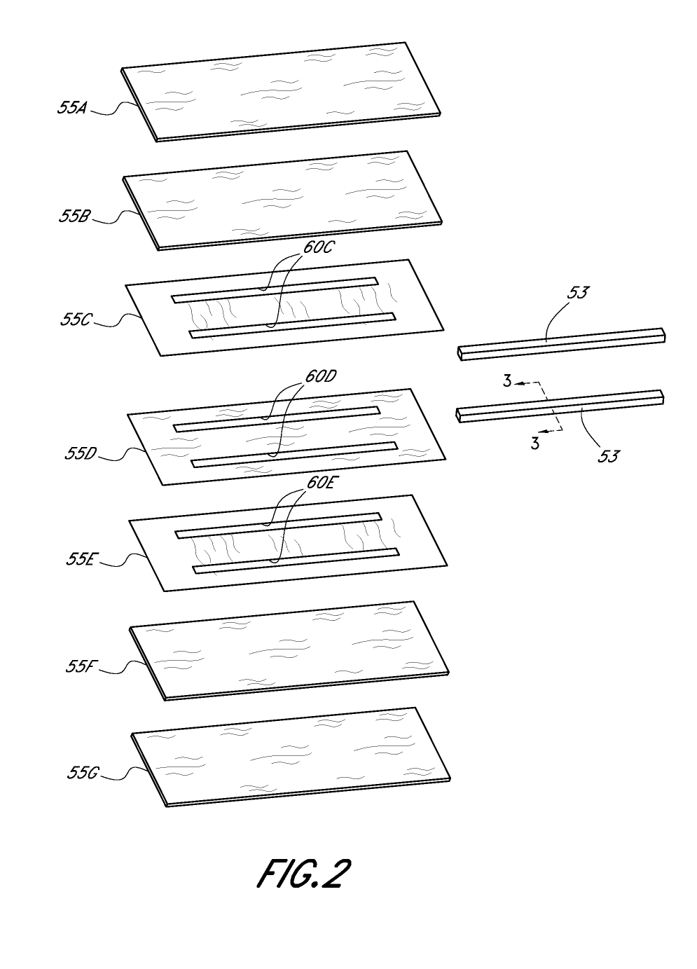

The illustrated embodiment preferably comprises several layers, or veneers, of wood that are glued and pressed together to form the skateboard deck 20. With reference next to FIG. 2, in one preferred embodiment, the skateboard deck 20 comprises seven veneers 55A-G of North American hard maple wood, each layer 55 being generally between about 0.04 and 0.07 inches thick, and more preferably between about 0.042 inches and 0.062 inches thick, resulting in an overall deck thickness between about 0.35 and 0.45 inches, or more preferably about 0.39 inches.

In a preferred embodiment, the seven veneers 55A-G comprise two upper layers 55A, B, two lower layers 55E, G, and three middle layers 55C-E. Preferably, the middle layers 55C-E, an uppermost layer 55A and a bottommost layer 55G are each about 0.062 inches in thickness. The remaining layers 55B, 55F preferably are about 0.042 inches thick. Thus, the overall thickness of the deck is about 0.394 inches. Of course, it is to be anticipated that, in other embodiments, wooden veneers of various thicknesses can be used, resulting in different thickness combinations and/or a different overall thickness.

Additionally, in the illustrated embodiment, the upper layers 55A, 55B, the lower layers 55F, 55G, and the middle layer 55D each are cut to have a grain generally longitudinally aligned with the longitudinal axis of the deck. However, the upper and lower ones 55C, 55E of the middle layers are cut to have a wood grain generally transverse to the longitudinal axis 32 of the skateboard deck 20. Again, it is to be understood that grain direction choice may be varied in other embodiments. Further, the type of wood can be varied, and materials other than wood, or even combinations of veneers of various materials, can be used.

With continued reference to FIG. 2, preferably elongate slots 60C-E are formed in each of the middle three layers 55C-E, respectively, of the deck 20 before these layers are adhered to each other and to the upper and lower layers. In one embodiment, each middle layer 55C-E is independently die cut prior to assembly of the layers. Other methods of cutting, such as routering and stamping, can be used as well. In another embodiment, the middle three layers 55C-E are first aligned with one another and then die cut or otherwise cut as a group. Preferably, the slots 60C-E of the middle layers 55C-E, respectively, generally align with one another to form a composite slot 60. During manufacture, the layers 55 are stacked on top of one another to form a deck 20. Preferably, an adhesive such as an epoxy is applied between the layers 55 to bond them together.

In one embodiment, the lower 55F, 55G and middle layers 55C-E are assembled first. This entails applying adhesive between the layers and stacking the layers. Before the upper layers 55A, 55B are put in place atop the middle layers 55C-E, reinforcement rods 53 are fit into the slots 60 formed in the middle layers 55C-E. The rods 53 preferably are sized and adapted to fit generally snug in the slots 60. Additionally, preferably the rods 53 are sized so as to have a thickness 66 that aligns with the aggregate thickness of the middle layers so that the upper surfaces of the rods are generally aligned with the upper surface of the uppermost middle layer 55C.

With the rods 53 in place, the upper layers 55A, 55B are then coated with adhesive and stacked into place. The assembled stack of layers 55A-G is then placed in a press that includes a mold. The press applies pressure to mold the assembled veneers into the desired concave and convex shape of the finished skateboard deck (see FIG. 1), and also applies heat to cure the adhesive so that the veneers are tightly bonded together to maintain the molded shape and withstand the rigors of high-performance skateboarding. After the adhesive has cured and the skateboard deck 20 properly shaped in the press, the deck is cut to the desired outer shape, preferably using a router. The illustrated embodiment depicts a traditional, elongated oval planform shape, but other symmetrical and asymmetrical shapes are contemplated. The finished skateboard deck preferably has the appearance of a traditional wood veneer skateboard, but has the rigid reinforcement rods wholly enclosed within the skateboard body.

Preferably, the elongate rods 53 are more rigid than the wood used to make the skateboard deck 20. Also, preferably the elongate rods 53 are lower in weight than the equivalent volume of wood removed to form the slots 60. As such, providing the rods 53 increases the overall rigidity and torsional stiffness of the skateboard deck 20 while decreasing its weight. Additionally, the rigid rods 53 preferably traverse the traditionally-vulnerable zone 50 at and around the inner mount apertures 48a.

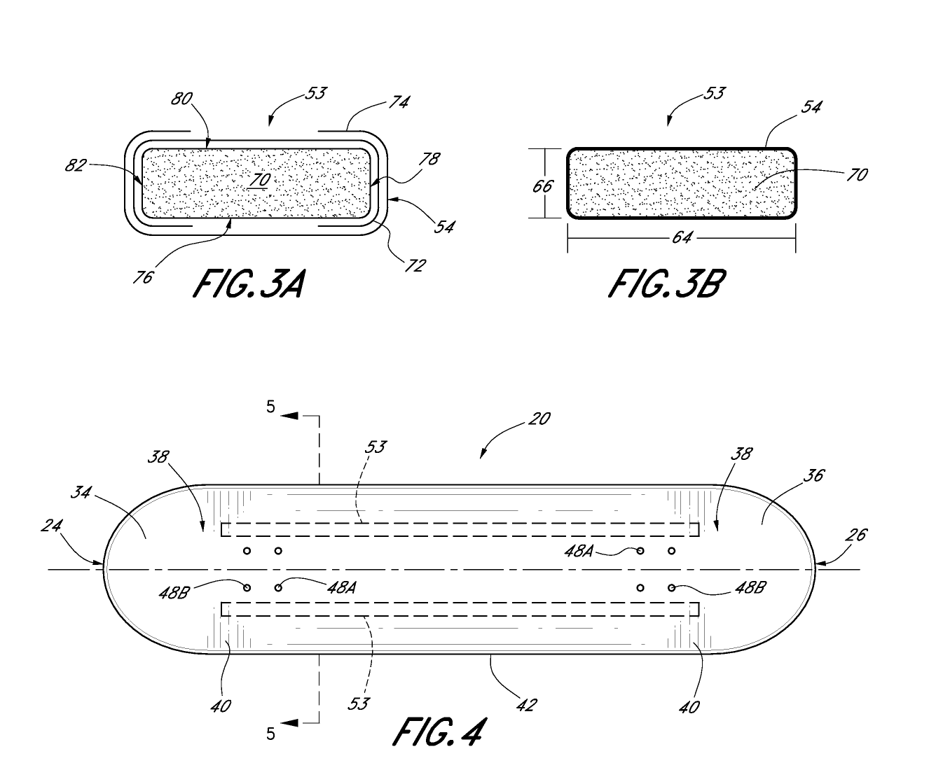

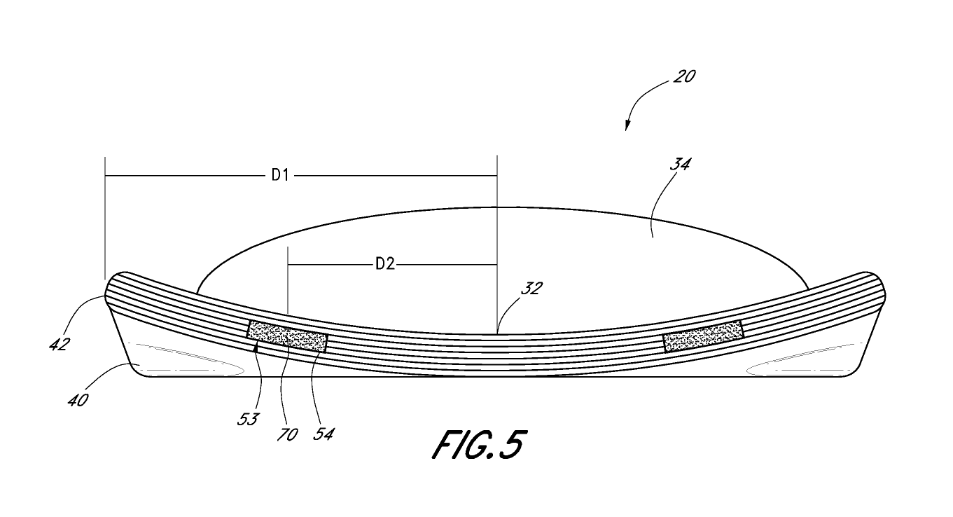

With next reference specifically to FIGS. 3a and 3b, an embodiment of an elongate rod 53 is illustrated in cross-section, shown schematically in FIG. 3a, and in a cured disposition in FIG. 3b. In this embodiment, the elongate rod 53 is generally rectangular in cross-section. The illustrated embodiment has a width 64 that is about four times its thickness 66. Preferably, a rod core 70 is formed from an expanded foam, such as a polyester foam, that is machined to a desired elongate, rectangular cross-sectional shape. In one embodiment, an expanded Kellocell® foam is used. In other embodiments, the foam core 70 can be molded substantially to its desired shape.

As depicted in FIG. 3a, preferably a fibrous cloth material 54 is wrapped about the foam core 70. In a preferred embodiment, a prepreg carbon fiber fabric is at least partially wrapped about the foam core 70. In the embodiment illustrated in FIG. 3a, a first layer 72 of prepreg carbon fiber fabric is wrapped about the foam core 70 so that the preponderance of fibers in the fabric are longitudinally aligned with a longitudinal axis of the core 70. The first layer 72 of prepreg carbon fiber preferably is wrapped beginning at a bottom face 76 of the core 70, around a first side 78, over a top face 80, around a second side 82, and back to the bottom face 76 of the core 70. A second layer 74 is wrapped beginning at the top face 80, around the first side 78, bottom face 76, and second side 82, and then back to the top face 80. The second layer 74 is arranged substantially opposite the first layer 72. Preferably, the first layer 72 does not extend entirely across the bottom face 76 and the second layer 74 does not extend entirely across the top face 80.

It is to be understood that, in other embodiments, fabric having fibers arranged in various directions can be employed, and one, two, three, or more layers can be used. Such layers may be wrapped less than one entire revolution about the foam core 70, as in the illustrated embodiment, or wrapped more than one revolution about the foam core. In one embodiment, a tacky prepreg carbon fiber tape material is used so that when wrapped about the core 70 it substantially sticks in place even before being cured. In another embodiment, fibrous fabric is wrapped about the core and is temporarily secured in place with a tape, staple, adhesive or any other suitable implement, method or the like. In yet another embodiment, a woven sock of carbon, aramid or glass fiber is drawn over the core. Also, while a prepreg material is preferred, it is to be understood that non-epoxy-impregnated materials can also be used, and epoxy may be applied to the fibers during manufacture of the skateboard deck.

Preferably, a non-cured, fiber-wrapped rod 53 as discussed above is assembled and inserted into the slots 60 formed in the middle layers 55C-E during manufacture. The non-cured rods 53 are somewhat malleable in this operation. The epoxy in the prepreg carbon fiber fabric is cured in the press along with the epoxy that adheres the wood layers together. As such, the rods take on and are cured into the desired mold shape, and provide rigidity and strength in that shape. Preferably, the expanded foam of the rod cores 70 are adapted to expand when subjected to heat during curing. As such, the expanding foam core will exert substantial pressure on the surrounding fiber fabric. Thus, the composite material 54 is sandwiched between the core 70 and the surrounding wood, resulting in a relatively high pressure being applied to the composite 54 during curing. This pressure helps maximize the cured strength and helps the rod 53 to better conform to the slot space 60 in which it is placed. FIG. 3a is a schematic representation showing an embodiment of first and second layers of fabric 72, 74 wrapped about the foam core 70, while FIG. 3b illustrates the carbon fiber in a cured configuration forming a shell 54 tightly fit about the foam core 70 as anticipated when the rods 53 are cured within the skateboard deck 20.

In another embodiment, the rods 53 are cured before being inserted into the slot. In such an embodiment the rods preferably are placed in a portion of the deck body 22 that experiences very little or substantially no curvature change during pressing and molding of the skateboard deck so that the rods do not excessively resist the pressing and molding processes. In some such embodiments, the foam core is substantially removed from the cured rod prior to being inserted into the veneer slots.

As best shown in FIGS. 1 and 4, the elongate rods 53 preferably are placed so as to be transversely spaced from the mount apertures 48. Preferably, however, the rods 53 pass through the lines 50 that extend transversely through the inner mount apertures 48a and also through an imaginary line that would pass transversely through the outer mount apertures 48b. In the illustrated embodiment, the rods 53 extend toward the ends 24, 26 of the deck 20 past the outer mount apertures 48b, but stop short of the tail sections 34, 36. Most preferably, the ends of the elongate rods 53 terminate in or short of the tail transition portions 38. Nevertheless, the rods 53 provide significant and substantial strength and rigidity to absorb and distribute impact forces experienced by the skateboard in the truck mount portion 44, 46 so as to strengthen that area of the skateboard deck 20 and resist wear and/or breakage.

Further, the arrangement of elongate rods 53 in both the right and left halves of the skateboard deck 20 contributes to the torsional rigidity of the skateboard deck 20, and thus the rods 53 make the skateboard deck 20 stronger and more rigid not only in longitudinal bending but also in torsion that may be experienced during advanced and aggressive maneuvers.

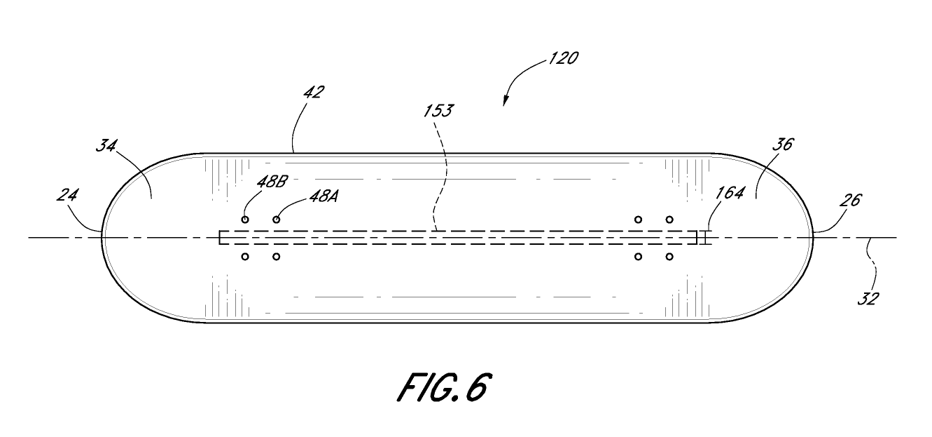

With reference next to FIG. 5, in the illustrated embodiment, rods 53 are disposed generally centrally in each transverse half of the skateboard deck 20. More specifically, distance D1 is a distance from the longitudinal center axis 32 to a side edge 42 of the skateboard deck 20, thus measuring a transverse right or left half of the deck 20. D2 represents a distance from the longitudinal axis 32 to the longitudinal center line of the elongate rod 53. Preferably, D2 is about half the distance of D1. Thus, the elongate rods 53 are centered within each of the right and left halves of the skateboard deck 20. This is considered a “centered in the half” configuration.

In another embodiment, the elongate rods 53 are positioned in each half of the deck so that a distance from the mount apertures 48 to a side of the rod 53 closest to the mount apertures 48 is about the same as a distance from an opposing side of the rod 53 to a side edge 42 of the skateboard deck 20. As such, the volume of contiguous wood between the edge 42 of the skateboard deck 20 and the rod 53 is substantially equal to the volume of contiguous wood between the skateboard truck mount apertures and the rod. This is considered a “centered between the deck edge and the mount apertures” configuration.

In other embodiments, the elongate rods 53 are placed in each half somewhere between the “centered in the half” placement of the illustrated embodiment and the “centered between the deck edge and the mount apertures” embodiment just discussed. In still other embodiments it may be desired to place the rods 53 even closer to the adjacent skateboard truck mount apertures 48 in order to place the rods 53 closer to the associated impact forces. Preferably, however, the rods 53 are spaced from the mount apertures 48 so that the apertures 48 are made through contiguous wood of the upper, lower and middle layers 55A-G.

Since the elongate rods 53 in the illustrated embodiment are completely enclosed within the skateboard deck 20 wood layers, no special tools are required for cutting, sanding, or otherwise treating the exterior and edges of the skateboard deck. Additionally, since only wood is exposed to tooling, such tooling will not be worn out any faster than with a typical wood skateboard deck, such as often occurs when carbon fiber or other materials are exposed along the edges 42 of the deck 20. Further, the generally-advantageous and durable behavior of laminated wood when exposed to the various scratches, dents, and impacts typical of skateboard use can be advantageous for the durability of the skateboard deck.

Although the illustrated embodiment uses seven veneers of North American hard maple wood, it is to be understood that, in other embodiments, other numbers of veneers having thicknesses other than as specifically set out in the illustrated embodiment can be used. Additionally, different materials, and even combinations of different materials, can be used. For example, layers of fiberglass, Kevlar (aramid), carbon fiber, bulk molding compound, plastic, or other materials can be used instead of, in addition to, or in combination with, woods of various types, hardnesses, and thicknesses.

Further, although the preferred embodiment employs rods 53 formed of carbon fiber-wrapped foam cores 70, other rigid rod constructions can be employed. For example, aramid and/or glass-fiber layers may be used instead of or in addition to carbon fiber layers, and other types of composites are also contemplated. Additionally, some embodiments may not use fiber materials, and instead may employ tubing materials, such as metals, that have increased rigidity relative to the adjacent wood or other layers. For example, in other embodiments, an elongate rectangular aluminum hollow tube may be used.

In yet another embodiment, because of the increased rigidity and strength imparted by the rigid elongate rods 53, a multi-layer skateboard deck can be constructed having even thinner veneers and/or less layers of wood than in the illustrated embodiment. Thus, the resulting skateboard can be thinner and lighter than a traditional, seven-layer wooden skateboard deck, yet retain or improve upon the strength of such a deck.

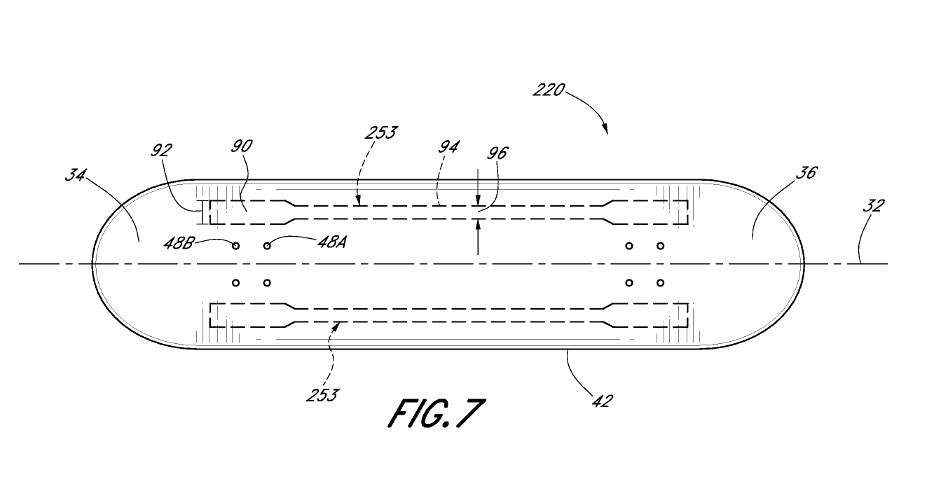

With reference next to FIG. 6, in yet another embodiment, a skateboard deck 120 is constructed having only a single elongate rigid rod 153. Such a rod may be placed in any desired portion of the skateboard deck 120. Preferably, however, the rod 153 is placed generally along the longitudinal axis 32 of the skateboard deck 120 as illustrated. Preferably, the elongate rod 153 has a width 164 that is not so wide as to interfere with the truck mount apertures 48. Thus, the apertures 48 are formed through layers of wood that are contiguous with the rest of the skateboard deck 120.

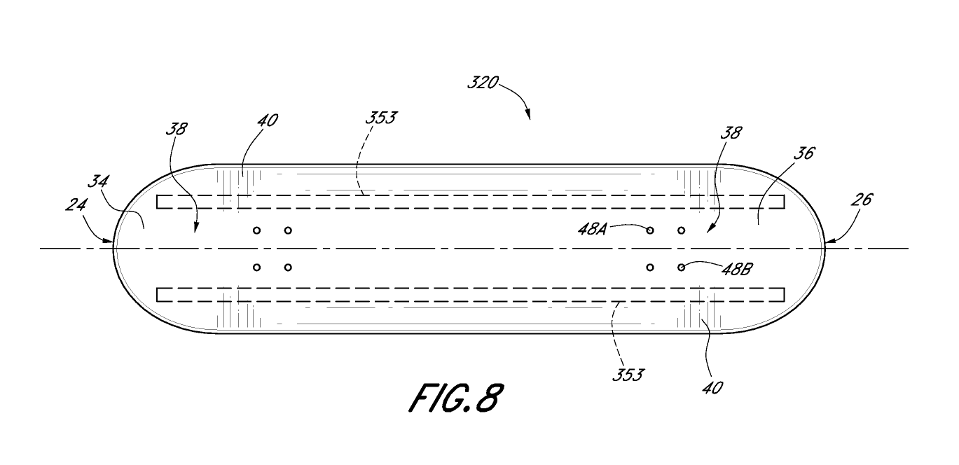

With reference next to FIG. 7, in another embodiment, the cross-sectional shape of the rods 253 can change along their length. For example, in the illustrated embodiment, each rod 253 has a widened portion 90 having a first width 92 and a narrowed portion 94 having a second width 96 that is narrower than the first width 92. In the illustrated embodiment, the rods are arranged so that the widened portions 90 are positioned at and around the vulnerability zone 50, and the narrowed portions 94 extend between the front and rear truck mount portions 44, 46 of the deck 20. Preferably, the slots 60 formed in the wood layers 55C-E are shaped to complement the shapes of the rods. Such embodiments having widened and narrowed portions 90, 94 may be adapted to provide more of a mechanical advantage and more impact resistance in the areas around the mount portions of the deck 220. For example, in one embodiment the widened portion of the corresponding core that is arranged near the truck mount portions comprises one or more generally vertical components of carbon fiber material between the vertical sides of the rod 253, further enhancing strength and impact force distribution in the area around the mount portion.

In another embodiment, the number and/or thickness of layers of composite extending along a side of the foam core in the parts of the rods between the truck mount portions is reduced relative to the composite thickness in parts of the rods adjacent the truck mount portions. As such, the skateboard deck retains an increased measure of flexibility in the area between the front and rear truck mount portions, yet is increasingly rigid and supportive in the area at or adjacent the truck mount portions. In this manner, the skateboard deck may have flex characteristics that even closer resemble a traditional wood deck, but decreased overall weight and also increased strength in the areas where traditional decks typically break. Further, this feature may be employed with rods of any cross-sectional shape, including those depicted in FIG. 4 or 7.

In accordance with yet another embodiment, elongate rods, such as rods with portions of varying widths, may also be arranged so that widened portions traverse the mount apertures 48 within the truck mount portions. In such an embodiment, the mount apertures 48 extend clear through the rods 53. Preferably, the rods have a width at the mount apertures 48 sufficient so that the mount apertures do not affect the strength of the rods. In still another embodiment, the core material of the rods in the widened portion can be constructed out of a material other than in other portions of the rods, such as the narrowed portion of the rods. For example, in one embodiment the widened portion may have a wood core that is especially conducive to bearing compression stresses incident to accommodating bolts that secure a truck mount plate onto the skateboard deck, yet the narrowed portion will have a light, foam core.

With reference next to FIG. 8, in another embodiment, elongate rods 353 extend through the tail transition portion 38 and into each tail portion 34, 36, spanning nearly the entire length of the deck 20. Preferably, however, the rods 353 do not extend to the ends 24, 26 of the deck 20, and the rods 353 are still encased fully within the wood layers.

In yet further embodiments the rods can extend all the way to the end of the board and can even be exposed at their ends. In one such embodiment the rods are completely hollow, providing a contiguous hollow tube extending from end-to-end.

In the illustrated embodiments, generally rectangular cross-section rods 53 have been employed. Other embodiments may employ rods of other cross-sectional shapes, such as a hexagonal shape. In such embodiments, the individual slots 60C-E that make up the slot may be configured slightly differently to best accommodate and complement the cross-sectional shape of the rod.

Embodiments have been specifically presented herein having a single rod or a pair of rods. It is to be understood that, in other embodiments, three rods, or even more rods, may be provided.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. For example, an embodiment employing rods having widened portions and narrowed portions as depicted in the embodiment illustrated in FIG. 7 may also include features of the embodiment depicted in FIG. 8, namely a length that extends substantially to or near the ends of the skateboard deck. Similarly, although the embodiment depicting rods with widened portions and narrowed portions is shown in connection with a two-rod embodiment, such features can be employed with, for example, a single rod embodiment as in that of FIG. 6, or with embodiments having three or more rods. Additionally, embodiments may employ one or more rods with widened portions and narrowed portions in combination with one or more rods not having such widened portions. Still further, the geometry of the widened portions and narrowed portions of the rods as depicted in FIG. 7 can be varied to accommodate particular purposes. It should be understood that various features and aspects of the disclosed embodiments can be combined with or substituted for one another in order to form varying modes of the disclosed invention not specifically disclosed in the embodiments disclosed herein. Thus, it is intended that the scope of the present invention herein disclosed should not be limited by the particular disclosed embodiments described above, but should be determined only by a fair reading of the claims that follow.

What is claimed is:

1. A skateboard deck, comprising:
a plurality of layers pressed and bonded together, the plurality of layers comprising an upper layer, a lower layer, and a middle layer, the middle layer having an elongate slot formed therein, the slot being generally parallel to a longitudinal axis of the skateboard deck;
a rigid reinforcement rod disposed in the elongate slot formed in the middle layer, the rod having a stiffness in bending greater than a stiffness in bending of the other layers; and
a plurality of mounting apertures extending through the upper, lower and middle layers;
wherein the elongate reinforcement rod extends longitudinally past the mounting apertures but is spaced from the mounting apertures.

2. A skateboard deck as in claim 1, wherein the elongate slot does not intersect with a perimeter edge of the middle layer so that the reinforcement rod is enclosed by the upper, middle and lower layers.

3. A skateboard deck as in claim 2, wherein the skateboard deck has a plurality of middle layers, and elongate slots are formed in each of the plurality of middle layers so that the elongate slots are aligned with one another, and wherein the rigid reinforcement rod is disposed in the aligned elongate slots.

4. A skateboard deck as in claim 2, wherein the reinforcement rod has a widened portion having a first width and a narrowed portion having a second width, and the first width is greater than the second width.

5. A skateboard deck as in claim 2, wherein the reinforcement rod has a composite wall, and a thickness of the composite wall varies along the length of the reinforcement rod.

6. A skateboard deck as in claim 1, comprising a second elongate slot formed in the middle layer and a second rigid reinforcement rod disposed in the second elongate slot, the first and second reinforcement rods being generally parallel to one another.

7. A skateboard deck as in claim 6, wherein the reinforcement rods comprise a cured composite shell.

8. A skateboard deck as in claim 7, wherein the cured composite shell generally encircles a foam core.

9. A skateboard deck as in claim 7, wherein the reinforcement rods have a generally rectangular cross-sectional shape.

10. A skateboard deck as in claim 6, wherein the first reinforcement rod is disposed on a first side of a longitudinal axis of the skateboard deck, and the second reinforcement rod is disposed on a second side of the longitudinal axis.

11. A skateboard deck as in claim 10, wherein the skateboard deck additionally comprises a truck mount portion, and each of the first and second reinforcement rods is disposed between the truck mount portion and a perimeter edge of the deck.

12. A method of making a skateboard deck, comprising,
providing a plurality of elongate layers of material, including an upper layer, a lower layer, and a plurality of middle layers;
cutting an elongate slot in each middle layer;
providing an elongate reinforcement rod having a length and width generally corresponding to a length and width of the elongate slot, and a thickness generally corresponding to an aggregate thickness of the plurality of middle layers;
aligning the elongate slots of the middle layers;
placing the reinforcement rod into the aligned elongate slots;
assembling the upper, middle, and lower layers and applying an epoxy between the upper, middle, and lower layers;
placing the assembled layers in a press;
curing the epoxy in the press; and
forming mounting apertures in the deck for attaching a wheel mechanism;
wherein the elongate slots are spaced from the mounting holes but extend longitudinally on either side of the mounting holes.

13. A method as in claim 12, wherein providing the rod comprises providing an elongate foam member and wrapping the foam member with a prepreg fibrous fabric material.

14. A method as in claim 13, wherein the prepreg material is co-cured with the epoxy in the press.

15. A method as in claim 14, wherein the prepreg material is tacky so that it stays in place while being manipulated.

16. A method as in claim 13, wherein the foam member is adapted to expand upon heating, and wherein curing the epoxy in the press comprises applying heat such that the foam member expands and exerts a force on the fibrous fabric material.

17. A method as in claim 16, wherein the prepreg fibrous fabric material comprises carbon fiber.
